(19) United States
(12) Patent Application Publication
(10) Pub. No.: US 2021/0287260 A1
(43) Pub. Date: Sep. 16, 2021

(54) ENCODING CONVERSATIONAL STATE AND SEMANTICS IN A DIALOGUE TREE TO FACILITATE AUTOMATED CUSTOMER-SUPPORT CONVERSATIONS

(71) Applicant: Zendesk, Inc., San Francisco, CA (US)

(72) Inventors: Soon-Ee Cheah, Bentleigh East (AU); Dana Ma, South Melbourne (AU)

(73) Assignee: Zendesk, Inc., San Francisco, CA (US)

(21) Appl. No.: 16/818,852

(22) Filed: Mar. 13, 2020

(51) Int. Cl. G06Q 30/02; G06Q 30/00; G06F 16/9032; H04L 12/58; G06F 40/30

(52) U.S. Cl. CPC G06Q 30/0281; G06Q 30/016; G06F 40/30; H04L 51/02; G06F 16/90332

(57) ABSTRACT

The disclosed embodiments relate to a system that automatically interacts with a customer during an automated customer-support conversation. The system first receives a textual input from the customer during the automated customer-support conversation, wherein the conversation relates to an issue the customer has with a product or a service used by the customer. Next, the system calculates a semantic embedding in a vector space for the textual input. The system then determines a new position in a predefined dialogue tree based on the calculated semantic embedding and a current position of the conversation in the dialogue tree, wherein the dialogue tree defines a structure for the conversation, including dialogue text, and predefined responsive customer-support actions for various customer inputs. Finally, the system navigates to the new position in the dialogue tree and performs a responsive customer-support action associated with the new position.

### BACKGROUND

### Field

The disclosed embodiments generally relate to computer-based systems that help businesses manage customer-support interactions. More specifically, the disclosed embodiments relate to a system that simultaneously encodes conversational state and semantics in a dialogue tree to facilitate automated customer-support conversations.

### Related Art

As electronic commerce continues to proliferate, customers are beginning to use online customer-support resources to help resolve problems, and to obtain information related to various products or services. These online customer-support resources are designed to help customers, by: providing helpful information to the customers; directing customers to specific workflows; or facilitating interactions with customer-support agents. When designed properly, these online customer-support resources can automate many customer-support interactions, thereby significantly reducing a company's customer-support costs.

In an automated customer-support system, it is advantageous to be able to have a conversation with the customer. For example, when the customer first accesses the automated customer-support system, the system might ask “How can I help you?” In response, the customer might ask “How do I share my desktop?” The system might then ask a follow-up question “What browser are you using?” and the associated options might be “Chrome,” “Firefox,” or “other.” If the customer selects “other,” the system might answer “Only Chrome and Firefox are supported.” Note that for each customer input in the conversation, the system needs to provide an appropriate response.

During an automated customer-support conversation, it is advantageous to be able to guide a customer through a predefined “dialogue tree” that aids in the diagnosis and resolution of their customer-support issue. During this process, machine-learning techniques can be employed to analyze the semantic content of a customer's input to match this semantic content to corresponding semantic content associated with each node in the dialogue tree. While this approach generates a response that is consistent with the semantic content of a most-recent customer input in a conversation, it is unable to simultaneously consider contextual information associated with the state of the conversation. This results in a situation where a customer who is traversing a specific branch of a dialogue tree may be unintentionally directed to an unrelated branch of the dialogue tree, due to a node in the unrelated branch sharing similar semantics to the customer's most-recent input. (For example, if a customer is attempting to return a product, it is undesirable to direct the customer to a branch of the dialogue tree that provides a tutorial about a feature of the product because the customer's most-recent input mentioned the feature.) This sudden transition to an unrelated branch disrupts the flow of the conversation and consequently provides a poor and unnatural user experience. One possible solution to this problem is to enforce a blanket rule that prevents the system from selecting nodes outside the branch of the dialogue tree that a customer is presently traversing. However, this creates a situation where a customer is unable to change the topic of a conversation and move to a different part of the dialogue tree, even if this is the customer's intention.

Hence, what is needed is a technique that facilitates keeping a customer within a specific branch of the dialogue tree during a conversation, but is also capable of switching to other branches of the dialogue tree should a customer clearly specify their intent to change the topic of a conversation.

### SUMMARY

The disclosed embodiments relate to a system that automatically interacts with a customer during an automated customer-support conversation. During operation, the system receives a textual input from the customer during the automated customer-support conversation, wherein the conversation relates to an issue the customer has with a product or a service used by the customer. Next, the system calculates a semantic embedding in a vector space for the textual input. The system then determines a new position in a predefined dialogue tree based on the calculated semantic embedding and a current position of the conversation in the dialogue tree, wherein the dialogue tree defines a structure for the conversation, including dialogue text, and predefined responsive customer-support actions for various customer inputs. Finally, the system navigates to the new position in the dialogue tree and performs a responsive customer-support action associated with the new position.

In some embodiments, the responsive customer-support action comprises presenting one or more helpful articles to the customer to facilitate resolving the customer's issue.

In some embodiments, the responsive customer-support action comprises putting the customer in touch with a human customer-support agent to help resolve the customer's issue.

In some embodiments, the responsive customer-support action comprises triggering a predefined workflow to help resolve the customer's issue.

In some embodiments, the predefined workflow can be associated with one or more of the following: obtaining status information for an order; changing a delivery address for an order; issuing a refund for an order; issuing an exchange for an order; resetting the customer's password; updating details of the customer's account; and canceling the customer's account.

In some embodiments, calculating the semantic embedding for the textual input involves calculating a Doc2Vec embedding for the textual input.

In some embodiments, the customer-support system additionally calculates a semantic embedding and a positional embedding for each node in the dialogue tree. During this process, for each node, the system calculates a semantic embedding for the node based on dialogue text associated with the node. If the node is a root node, the system calculates the positional embedding for the node to be equal to the node's semantic embedding. Otherwise, the system calculates the positional embedding for the node to be a weighted average of the semantic embedding for the node and a positional embedding for a parent node of the node.

In some embodiments, while determining the new position in the dialogue tree, the system first retrieves a positional embedding associated with a current position of the conversation in the dialogue tree. Next, the system calculates a new positional embedding by taking a weighted average of the semantic embedding for the textual input and the retrieved positional embedding. The system then compares the new positional embedding against previously calculated positional embeddings for all positions in the dialogue tree. Finally, the system selects a position in the dialogue tree associated with a best-matching positional embedding to be the new position.

In some embodiments, a weighting parameter is used while taking the weighted average of the semantic embedding for the textual input and the positional embedding, wherein the weighting parameter controls a propensity of the method to keep the conversation within a current branch of the dialogue tree.

In some embodiments, the system biases the determination of the new position based on context information and/or status information associated with the customer. For example, if the customer is a VIP, the system can bias the conversation toward getting a human customer-support agent in the loop to help deal with the issue. Or, if the customer ordered a product last week, the system can bias the conversation toward an order status workflow. In another example, if a client has an active shopping cart and has not checked out yet, the system can bias the conversation toward a checkout workflow.

### BRIEF DESCRIPTION OF THE FIGURES

FIG. 1 illustrates an exemplary computing environment including an application and associated customer-support system in accordance with the disclosed embodiments.

FIG. 2 illustrates how a customer interacts with an automated customer-support system in accordance with the disclosed embodiments.

FIG. 3 illustrates an exemplary dialogue tree in accordance with the disclosed embodiments.

FIG. 4 presents a flowchart illustrating a process for automatically interacting with a customer during an automated customer-support conversation in accordance with the disclosed embodiments.

FIG. 5 presents a flowchart illustrating a process for calculating a semantic embedding and a positional embedding for each node in the dialogue tree in accordance with the disclosed embodiments.

Table I presents some exemplary code for calculating and manipulating positional embeddings in a dialogue tree in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Computing Environment

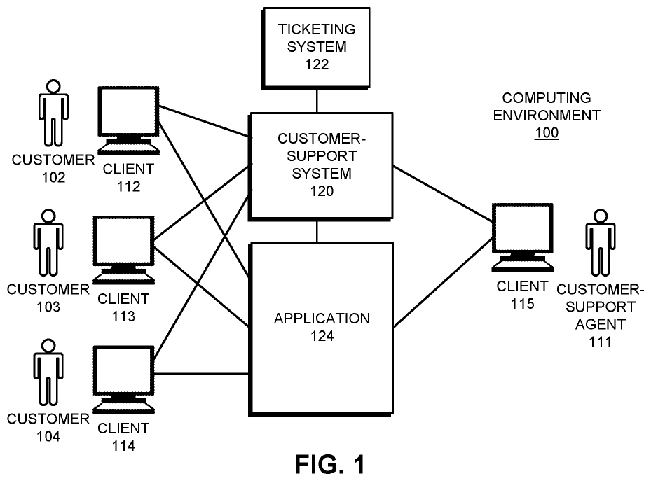

FIG. 1 illustrates an exemplary computing environment 100, which includes an application 124 and a customer-support system 120 in accordance with the disclosed embodiments. Within computing environment 100, a number of customers 102-104 interact with application 124 through client computer systems 112-114, respectively. Application 124 is provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems or questions about application 124, they can access a customer-support system 120 to obtain help in dealing with issues, which can include various problems and questions. For example, a user of accounting software may need help in using a feature of the accounting software, or a customer of a website that sells sporting equipment may need help in canceling an order that was erroneously entered. This help may be provided by a customer-support agent 111 who operates a client computer system 115 and interacts with customers 102-104 through customer-support system 120. This help may also comprise automatically suggested helpful articles that the customer can read to hopefully resolve the problem or question. Note that customer-support agent 111 can access application 124 (either directly or indirectly through customer-support system 120) to help resolve an issue.

In some embodiments, customer-support system 120 is not associated with computer-based application 124, but is instead associated with another type of product or service that is offered to a customer. For example, customer-support system 120 can provide assistance with a product, such as a television, or with a service such as a package-delivery service.

Customer-support system 120 organizes customer issues using a ticketing system 122, which generates tickets to represent each customer issue. Ticketing systems are typically associated with a physical or virtual “help center” (or “help desk”) for resolving customer problems. Note that, although the present invention is described with reference to a ticketing system, it is not meant to be limited to customer-service interactions involving ticketing systems. In general, the invention can be applied to any type of system that enables a customer to resolve a problem with a product or service provided by an organization.

Ticketing system 122 comprises a set of software resources that enable a customer to resolve an issue. In the illustrated embodiment, specific customer issues are associated with abstractions called “tickets,” which encapsulate various data and metadata associated with the customer requests to resolve an issue. An exemplary ticket can include a ticket identifier, and information (or links to information) associated with the problem. For example, this information can include: (1) information about the problem; (2) customer information for one or more customers who are affected by the problem; (3) agent information for one or more customer-service agents who are interacting with the customer; (4) email and other electronic communications about the problem (which, for example, can include a question posed by a customer about the problem); (5) information about telephone calls associated with the problem; (6) timeline information associated with customer-service interactions to resolve the problem, including response times and resolution times, such as a first reply time, a time to full resolution and a requester wait time; and (7) effort metrics, such as a number of communications or responses by a customer, a number of times a ticket has been reopened, and a number of times the ticket has been reassigned to a different customer-service agent. Within this specification, tickets are more generally referred to as “customer requests.”

### Conversation-Support System

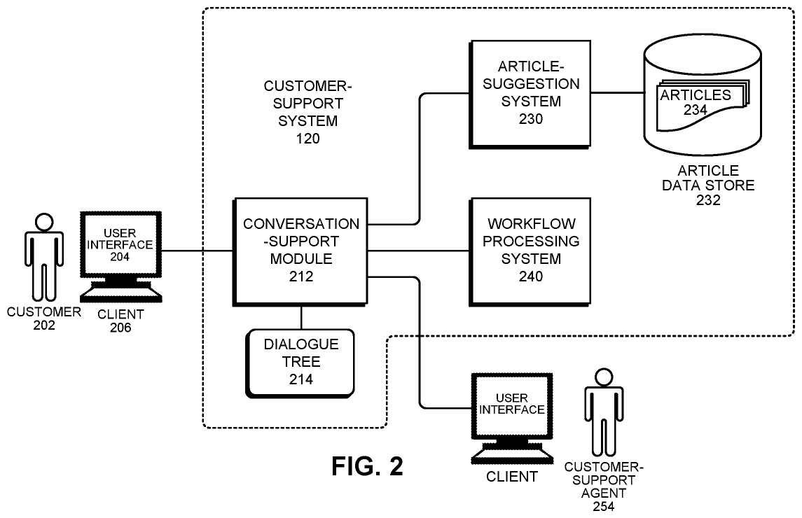

FIG. 2 illustrates how a customer interacts with an automated conversation-support module 212 within customer-support system 120 in accordance with the disclosed embodiments. During operation, a customer 202 who has an issue with a product or a service associated with application 124, interacts with customer-support system 120 through a user interface 204 in a client system 206. During this process, customer 202 submits a request to customer-support system 120 to obtain help with the issue, thereby initiating an automated customer-support conversation. (Note that user interface 204 can be implemented in a number of different ways for both mobile and desktop platforms. For example, user interface 204 can be incorporated into: a web page, an email, or a UI screen provided by an application.)

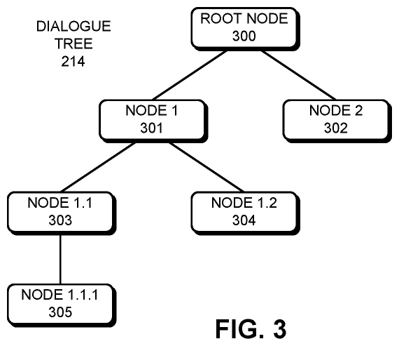

The request from customer 202 is directed to a conversation-support module 212 within customer-support system 120. During operation, conversation-support module 212 makes use of a predefined dialogue tree 214 to keep track of an ongoing conversation with customer 202. The structure of dialogue tree 214 is described in more detail below with reference to FIG. 3.

As a result of this conversation, conversation-support module 212 can perform various responsive customer-support actions. For example, conversation-support module 212 can cause customer 202 to receive one or more helpful articles from an article-suggestion system 230 to facilitate resolving the customer's issue. During this process, article-suggestion system 230 obtains the one or more helpful articles from a set of help center articles 234 contained in an article data store 232. Conversation-support module 212 can alternatively trigger a predefined workflow from workflow processing system 240 to help resolve the customer's issue. For example, the predefined workflow can be associated with one or more of the following: obtaining status information for an order; changing a delivery address for an order; issuing a refund for an order; issuing an exchange for an order; resetting the customer's password; updating details of the customer's account; and canceling the customer's account. As another alternative, conversation-support module 212 can put the customer 202 in touch with a human customer-support agent 254 to help resolve the customer's issue. The customer's issue will hopefully be resolved through one or more of these customer-support actions.

### Dialogue Tree

FIG. 3 illustrates an exemplary dialogue tree 214 in accordance with the disclosed embodiments. Dialogue tree 214 defines a structure for the conversation, including dialogue text for both speakers in a conversation, and predefined responsive customer-support actions for various customer inputs. To facilitate navigational operations, dialogue tree 214 includes an associated semantic embedding and positional embedding for each node in the tree.

As mentioned above, the positional embedding for each node in dialogue tree 214 is the weighted average of the semantic embedding for the node and the positional embedding for the parent node of the node. For example, within dialogue tree 214, the positional embedding of node 1.1.1 305 is the weighted average of its own semantic embedding and the positional embedding of node 1.1 303, where the positional embedding of node 1.1 303 itself is the weighted average of its own semantic embedding and the positional embedding of node 1 301. This process is repeated until the root node 300 is reached, where the semantic and positional embeddings of root node 300 are equivalent. Note that by incorporating positional information as well semantic information into each node embedding, it is less likely that a customer will be directed to an unrelated branch of the dialogue tree, due to a node in the unrelated branch sharing similar semantics to the customer's most-recent input. (Exemplary code for calculating and manipulating positional embeddings is presented in Table I.)

### Facilitating an Automated Customer-Support Conversation

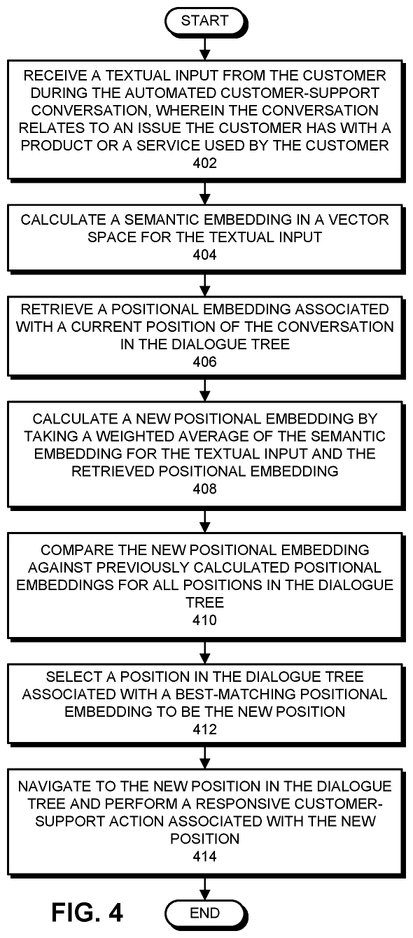

FIG. 4 presents a flowchart illustrating a process for automatically interacting with a customer during an automated customer-support conversation in accordance with the disclosed embodiments. First, the system receives a textual input from the customer during the automated customer-support conversation, wherein the conversation relates to an issue the customer has with a product or a service used by the customer (step 402). Next, the system calculates a semantic embedding in a vector space for the textual input (step 404). The system then retrieves a positional embedding associated with a current position of the conversation in the dialogue tree (step 406). Next, the system calculates a new positional embedding by taking a weighted average of the semantic embedding for the textual input and the retrieved positional embedding (step 408). The system then compares the new positional embedding against previously calculated positional embeddings for all positions in the dialogue tree (step 410).

Next, the system selects a position in the dialogue tree associated with a best-matching positional embedding to be the new position (step 412). Finally, the system navigates to the new position in the dialogue tree and performs a responsive customer-support action associated with the new position (step 414).

For example, suppose a customer is in the process of returning a product and the customer's textual input asks about details of an associated refund. In this case, the semantic embedding with include semantic information about the associated refund and the positional embedding will point to a branch of the dialogue tree that deals with product returns. In this case, the new positional embedding will be a weighted average of the refund-related semantic embedding and the product-return-related positional embedding. This new positional embedding will hopefully match with a new position in the dialogue tree that describes details about refunds for product returns.

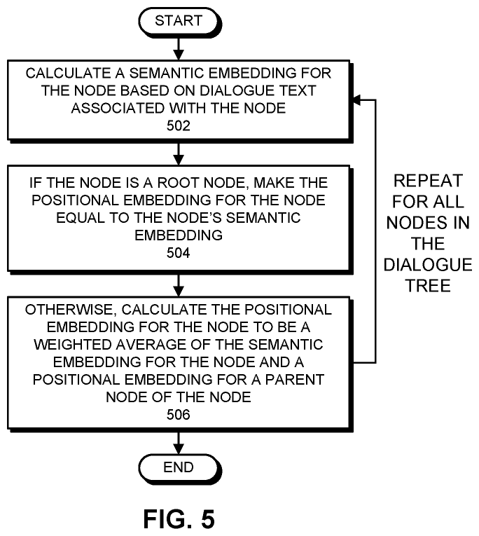

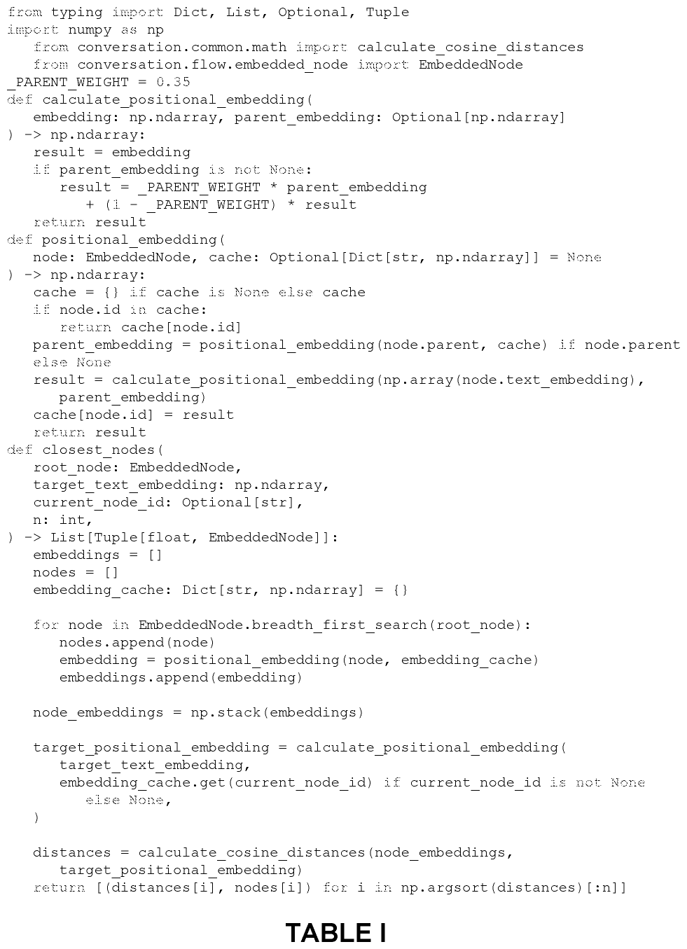

FIG. 5 presents a flowchart illustrating a process for calculating a semantic embedding and a positional embedding for each node in the dialogue tree in accordance with the disclosed embodiments. During this process, the system performs the following operations for each node in the dialogue tree. First, the system calculates a semantic embedding for the node based on dialogue text associated with the node (step 502). If the node is a root node, the system makes the positional embedding for the node equal to the node's semantic embedding (step 504). Otherwise, the system calculates the positional embedding for the node to be a weighted average of the semantic embedding for the node and a positional embedding for a parent node of the node (step 506).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for automatically interacting with a customer during an automated customer-support conversation, the method comprising:
receiving a textual input from the customer during the automated customer-support conversation, wherein the conversation relates to an issue the customer has with a product or a service used by the customer;
calculating a semantic embedding in a vector space for the textual input;
determining a new position in a predefined dialogue tree based on the calculated semantic embedding and a current position of the conversation in the dialogue tree, wherein the dialogue tree defines a structure for the conversation, including dialogue text, and predefined responsive customer-support actions for various customer inputs; and
navigating to the new position in the dialogue tree and performing a responsive customer-support action associated with the new position.

2. The method of claim 1, wherein the responsive customer-support action comprises presenting one or more helpful articles to the customer to facilitate resolving the customer's issue.

3. The method of claim 1, wherein the responsive customer-support action comprises putting the customer in touch with a human customer-support agent to help resolve the customer's issue.

4. The method of claim 1, wherein the responsive customer-support action comprises triggering a predefined workflow to help resolve the customer's issue.

5. The method of claim 4, wherein the predefined workflow can be associated with one or more of the following:
obtaining status information for an order;
changing a delivery address for an order;
issuing a refund for an order;
issuing an exchange for an order;
resetting the customer's password;
updating details of the customer's account; and
canceling the customer's account.

6. The method of claim 1, wherein calculating the semantic embedding for the textual input involves calculating a Doc2Vec embedding for the textual input.

7. The method of claim 1, wherein the method further comprises calculating a semantic embedding and a positional embedding for each node in the dialogue tree, which involves, for each node:
calculating a semantic embedding for the node based on dialogue text associated with the node;
if the node is a root node, calculating the positional embedding for the node to be equal to the node's semantic embedding; and
otherwise, calculating the positional embedding for the node to be a weighted average of the semantic embedding for the node and a positional embedding for a parent node of the node.

8. The method of claim 7, wherein determining the new position in the dialogue tree involves:
retrieving a positional embedding associated with a current position of the conversation in the dialogue tree;
calculating a new positional embedding by taking a weighted average of the semantic embedding for the textual input and the retrieved positional embedding;
comparing the new positional embedding against previously calculated positional embeddings for all positions in the dialogue tree; and
selecting a position in the dialogue tree associated with a best-matching positional embedding to be the new position.

9. The method of claim 1, wherein a weighting parameter is used while taking the weighted average of the semantic embedding for the textual input and the positional embedding, wherein the weighting parameter controls a propensity of the method to keep the conversation within a current branch of the dialogue tree.

10. The method of claim 1, wherein determining the new position in the dialogue tree additionally involves biasing the determination of the new position based on context information and/or status information associated with the customer.

11. A non-transitory computer-readable storage medium storing instructions that when executed by a computer cause the computer to perform a method for automatically interacting with a customer during an automated customer-support conversation, the method comprising:
receiving a textual input from the customer during the automated customer-support conversation, wherein the conversation relates to an issue the customer has with a product or a service used by the customer;
calculating a semantic embedding in a vector space for the textual input;
determining a new position in a predefined dialogue tree based on the calculated semantic embedding and a current position of the conversation in the dialogue tree, wherein the dialogue tree defines a structure for the conversation, including dialogue text, and predefined responsive customer-support actions for various customer inputs; and
navigating to the new position in the dialogue tree and performing a responsive customer-support action associated with the new position.

12. The non-transitory computer-readable storage medium of claim 11, wherein the responsive customer-support action comprises presenting one or more helpful articles to the customer to facilitate resolving the customer's issue.

13. The non-transitory computer-readable storage medium of claim 11, wherein the responsive customer-support action comprises putting the customer in touch with a human customer-support agent to help resolve the customer's issue.

14. The non-transitory computer-readable storage medium of claim 11, wherein the responsive customer-support action comprises triggering a predefined workflow to help resolve the customer's issue.

15. The non-transitory computer-readable storage medium of claim 14, wherein the predefined workflow can be associated with one or more of the following:
obtaining status information for an order;
changing a delivery address for an order;
issuing a refund for an order;
issuing an exchange for an order;
resetting the customer's password;
updating details of the customer's account; and
canceling the customer's account.

16. The non-transitory computer-readable storage medium of claim 11, wherein calculating the semantic embedding for the textual input involves calculating a Doc2Vec embedding for the textual input.

17. The non-transitory computer-readable storage medium of claim 11, wherein the method further comprises calculating a semantic embedding and a positional embedding for each node in the dialogue tree, which involves, for each node:
calculating a semantic embedding for the node based on dialogue text associated with the node;
if the node is a root node, calculating the positional embedding for the node to be equal to the node's semantic embedding; and
otherwise, calculating the positional embedding for the node to be a weighted average of the semantic embedding for the node and a positional embedding for a parent node of the node.

18. The non-transitory computer-readable storage medium of claim 17, wherein determining the new position in the dialogue tree involves:
retrieving a positional embedding associated with a current position of the conversation in the dialogue tree;
calculating a new positional embedding by taking a weighted average of the semantic embedding for the textual input and the retrieved positional embedding;
comparing the new positional embedding against previously calculated positional embeddings for all positions in the dialogue tree; and
selecting a position in the dialogue tree associated with a best-matching positional embedding to be the new position.

19. The non-transitory computer-readable storage medium of claim 11, wherein a weighting parameter is used while taking the weighted average of the semantic embedding for the textual input and the positional embedding, wherein the weighting parameter controls a propensity of the method to keep the conversation within a current branch of the dialogue tree.

20. The non-transitory computer-readable storage medium of claim 11, wherein determining the new position in the dialogue tree additionally involves biasing the determination of the new position based on context information and/or status information associated with the customer.

21. A system that automatically interacts with a customer during an automated customer-support conversation, comprising:
at least one processor and at least one associated memory; and
a customer-support system, which executes on the at least one processor, wherein during operation, the customer-support system:
receives a textual input from the customer during the automated customer-support conversation, wherein the conversation relates to an issue the customer has with a product or a service used by the customer;
calculates a semantic embedding in a vector space for the textual input;
determines a new position in a predefined dialogue tree based on the calculated semantic embedding and a current position of the conversation in the dialogue tree, wherein the dialogue tree defines a structure for the conversation, including dialogue text, and predefined responsive customer-support actions for various customer inputs; and
navigates to the new position in the dialogue tree and performs a responsive customer-support action associated with the new position.

22. The system of claim 21, wherein while performing the responsive customer-support action, the customer-support system presents one or more helpful articles to the customer to facilitate resolving the customer's issue.

23. The system of claim 21, wherein while performing the responsive customer-support action, the customer-support system puts the customer in touch with a human customer-support agent to help resolve the customer's issue.

24. The system of claim 21, wherein while performing the responsive customer-support action, the customer-support system triggers a predefined workflow to help resolve the customer's issue.

25. The system of claim 24, wherein the predefined workflow can be associated with one or more of the following:
obtaining status information for an order;
changing a delivery address for an order;
issuing a refund for an order;
issuing an exchange for an order;
resetting the customer's password;
updating details of the customer's account; and
canceling the customer's account.

26. The system of claim 21, wherein while calculating the semantic embedding for the textual input, the customer-support system calculates a Doc2Vec embedding for the textual input.

27. The system of claim 21, wherein the customer-support system additionally calculates a semantic embedding and a positional embedding for each node in the dialogue tree, wherein for each node, the customer-support system:
calculates a semantic embedding for the node based on dialogue text associated with the node;
if the node is a root node, calculates the positional embedding for the node to be equal to the node's semantic embedding; and
otherwise, calculates the positional embedding for the node to be a weighted average of the semantic embedding for the node and a positional embedding for a parent node of the node.

28. The system of claim 27, wherein while determining the new position in the dialogue tree, the customer-support system:
retrieves a positional embedding associated with a current position of the conversation in the dialogue tree;
calculates a new positional embedding by taking a weighted average of the semantic embedding for the textual input and the retrieved positional embedding;
compares the new positional embedding against previously calculated positional embeddings for all positions in the dialogue tree; and
selects a position in the dialogue tree associated with a best-matching positional embedding to be the new position.

29. The system of claim 21, wherein a weighting parameter is used while taking the weighted average of the semantic embedding for the textual input and the positional embedding, wherein the weighting parameter controls a propensity of the method to keep the conversation within a current branch of the dialogue tree.

30. The system of claim 21, wherein while determining the new position in the dialogue tree, the customer-support system additionally biases the determination of the new position based on context information and/or status information associated with the customer.
